(19) United States
(12) Patent Application Publication
(10) Pub. No.: US 2010/0146268 A1
(43) Pub. Date: Jun. 10, 2010

(54) Method for Saving a File

(76) Inventors: Frans Eduard Van Dorsselaer, Sassenheim (NL); Krijn Franciscus Marie Zuyderhoudt, Leiden (NL); Freerk Andre de la Porte, Huis Ter Heide (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/530,143

(22) PCT Filed: Mar. 13, 2008
(86) PCT No.: PCT/NL2008/000080

§ 371 Date: Jan. 29, 2010

(30) Foreign Application Priority Data
Mar. 14, 2007 (NL) 1033542

(51) Int. Cl. H04L 9/00; H04L 9/08

(52) U.S. Cl. 713/165; 380/278; 380/44

(57) ABSTRACT

The present invention relates to a method for storing a file originating from a source location at a target location, comprising of receiving the file at the target location, storing the file at the target location, and encrypting the file irreversibly in at least a stored state at the target location using a key originating from the source location, this prior to storage at the target location. The invention also relates to a receiving device for storing a file originating from a source location at a target location and a system for storing a file originating from a source location at least one target location.

The present invention relates to a method for storing a file originating from a source location at a target location, comprising of receiving the file at the target location and storing the file at the target location.

Such methods are for instance known for making a backup of a file. When making a backup of a file, the owner stores a copy of the file. In the case the original file is for instance lost or damaged, this owner can use the copy. In order to prevent both the original file and the copy thereof getting lost or damaged, the owner can for instance store the copy on a mobile storage medium such as a CD, a DVD or a portable hard disk. He/she can then take this medium to another location, for instance to a (good) friend who then takes the storage medium into safekeeping. The owner can also send a copy of the file to another location, for instance to the computer of a friend or service provider, for instance via a network such as a LAN (Local Area Network) or the internet. The file can then be stored there in a local storage medium.

The recipient will not want to take any random file into safekeeping. If the content of the file is for instance illegal, he/she may be held responsible for the content thereof. In order to prevent this he/she will want to know the content of the file before taking the file into safekeeping. However, by reading the content of the file he/she violates the privacy of the owner of the file and possibly exposes him/herself to the for instance illegal content of the file. A drawback of the known methods is here that, without opening the file and reading the content thereof, the recipient does not know for certain that he/she is not taking into safekeeping a file with a content for which he/she does not wish to be responsible. In the case the recipient wholly trusts the owner of the copy, this may not be such a great problem. On the internet however, where people for instance know each other only via internet and trust each other less, it could be. The uncertainty about the content of the file which the recipient takes into safekeeping discourages people, and for instance also companies, from making available storage space which they are not using, for instance for a backup.

The invention has for its object to obviate or at least alleviate this drawback of the known methods.

The invention is distinguished for this purpose by encrypting the file irreversibly in at least a stored state at the target location using a key originating from the source location, this prior to storage at the target location. This is preferably an automated, unavoidable process. The recipient could otherwise read the content prior to encryption of the file. Because the file is irreversibly encrypted at the target location using a key originating from the source location, the recipient knows for certain that he/she cannot read or have read the content of the file he/she is taking into safekeeping. Nor therefore can the recipient be held responsible for this content.

In an additional embodiment hereof the irreversible encryption of the file comprises of asymmetric encryption of the file using a public key originating from the source location. This measure forms a simple, reliable and moreover accepted method of irreversibly encrypting the file for the recipient at the target location. Once the file has been encrypted using the public key of the owner, the file can only be decrypted using the private key of the owner of the file, which is associated with the public key. It is impossible for the recipient to decrypt the asymmetrically encrypted file and thus read the content.

In an alternative embodiment hereof the irreversible encryption of the file comprises of generating a symmetric key, symmetrically encrypting the file using the symmetric key, and asymmetrically encrypting the symmetric key using a public key originating from the source location. These measures form a faster method of irreversibly encrypting the file. Symmetric encryption of the file is substantially as safe as asymmetric encryption and is faster, but is not irreversible for the person performing the encryption. Generating a random symmetric key in order to encrypt the file and encrypting this symmetric key asymmetrically, and thereby irreversibly, using the public key of the owner achieves the same effect as with asymmetric encryption of the whole file, but is faster.

In an additional embodiment of the method according to the invention the method comprises of irreversibly encrypting the file after receipt.

In a further additional embodiment of the method according to the invention the target location is a network location such as an internet location or a LAN (Local Area Network) location.

In a further additional embodiment of the method according to the invention the method comprises of encrypting the file prior to receipt using a key originating from the source location. This measure makes it possible for the content of the file to be already unreadable to the recipient at the target location before receipt at the target location. This has the advantage that the recipient knows with more certainty that the content of the file he/she is taking into safekeeping cannot be read by him/her. In addition, this measure has the advantage that the owner of the file is also certain that the recipient cannot read the content of the file.

In an additional embodiment hereof the encryption of the file prior to receipt comprises of asymmetrically encrypting the file using a public key originating from the source location. This measure forms a simple, reliable and moreover accepted method of encrypting the file, so that the content of the file cannot be read by the recipient.

In an alternative embodiment hereof the encryption of the file prior to receipt comprises of generating a symmetric key, symmetrically encrypting the file using the symmetric key, and asymmetrically encrypting the symmetric key using a public key originating from the source location. These measures form a method of encrypting the file which is more rapid than the method in which the whole file is asymmetrically encrypted. This has the advantage for instance that it is more attractive for the owner to encrypt the file irreversibly before the recipient takes the file into safekeeping.

In a further additional embodiment of the method according to the invention the method comprises of compressing the file prior to receipt. This has the advantage that the file can be processed and sent more easily and more quickly.

In a further additional embodiment of the method according to the invention the method comprises of dividing the file into at least two part-files prior to receipt. In an additional embodiment hereof the method comprises of distributing the part-files over more than one target location. In a further additional embodiment thereof the method comprises of distributing the part-files over the target locations such that no one target location stores all of the part-files. These measures make it possible that no single recipient has a complete file in safekeeping. This has the advantage that the recipient knows with more certainty that the content of the file he/she is taking into safekeeping cannot be read by him/her. In addition, this measure has the advantage that the owner of the file is also certain that the recipient cannot read the content of the file. It is thus attractive for the owner of the file to encrypt the file so that it is unreadable for the recipient. In an additional or alternative embodiment hereof the method comprises of distributing the part-files over the target locations by means of an error correction algorithm, for instance a Reed Solomon error correction algorithm. This measure for instance makes it possible, in the case a number of the part-files are lost or damaged at a target location, to still be able to reconstruct the whole file from the remaining part-files. This has the advantage that it is for instance more attractive for the owner of the file to distribute the file in part-files over more than one target file.

The invention also relates to a receiving device for storing a file originating from a source location at a target location, comprising a receiving unit which receives the file at the target location, an encryption unit which encrypts the file at the target location, a storage unit which stores the file at the target location, wherein the encryption unit encrypts the file irreversibly using a key originating from the source location. A recipient, who wishes to take files into safekeeping for others but who does not want to be responsible for the content thereof, can arrange such a device at the target location. He/she then knows for certain that it is impossible for him/her to read the content of all the files received and stored via this receiving device. Such a receiving device thus makes it possible in simple manner for the recipient to be certain that he/she cannot read the content of files he/she takes into safekeeping.

The invention also relates to a system for storing a file originating from a source location at least one target location, comprising a transmitting device at the source location which transmits the file from the source location to the at least one target location, and a receiving device at the at least one target location, comprising a receiving unit which receives the file at the target location, an encryption unit which encrypts the file at the target location, a storage unit which stores the file at the target location, wherein the encryption unit encrypts the file irreversibly using a key originating from the source location. In an additional embodiment hereof the transmitting device comprises at least one of a dividing unit, a compressing unit, a coding unit, an encryption unit and a distributing unit. Such a system makes it possible for both the owner and the recipient of a file to know for certain that the recipient cannot read the content of the file.

The present invention will be further elucidated hereinbelow on the basis of an exemplary embodiment as shown in the accompanying drawing. This is a non-limitative exemplary embodiment. In the drawing:

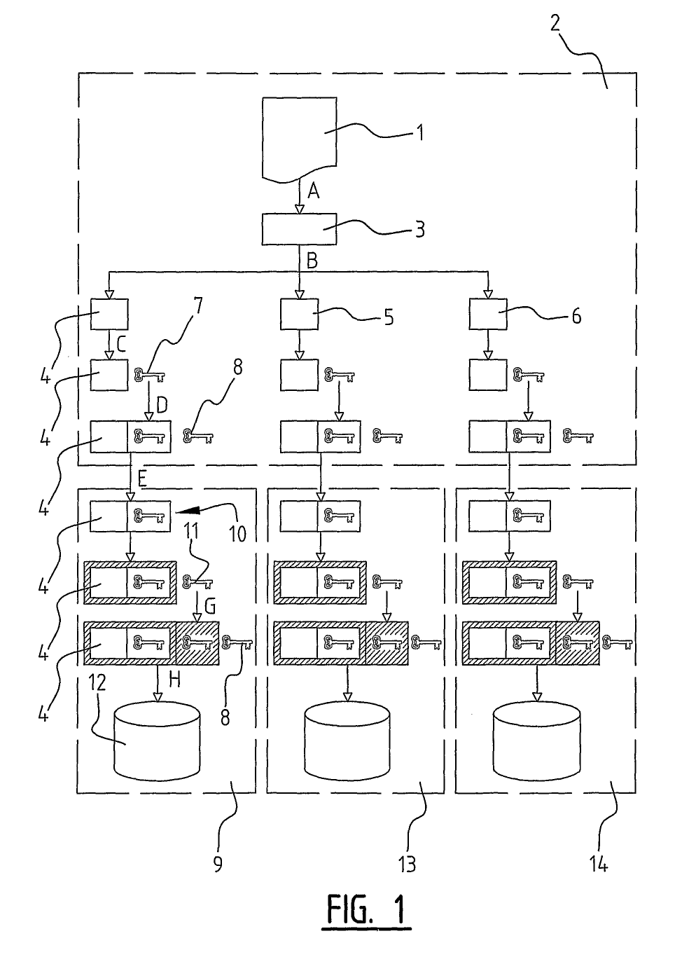

FIG. 1 shows a schematic representation of an embodiment of the method according to the invention.

FIG. 1 shows that file 1 is compressed at source location 2 to form compressed file 3 in a step indicated with arrow A. In a subsequent step, indicated by arrow B, the content of compressed source file 3 is distributed over the three part-files 4, 5 and 6 by means of an error correction algorithm. An error correction code can here be added to the content of at least one of the three part-files, so that the whole compressed file 3 can still be formed if for instance one of the three part-files is lost or damaged. Arrow C shows that part-file 4 is then encrypted symmetrically using a symmetric key 7. This symmetric key 7 is asymmetrically encrypted by means of a step indicated with arrow D using a public key 8 originating from target location 2. The symmetrically encrypted part-file 4 can then only be decrypted using the private key associated with public key 8. By keeping the private key secret it is certain that others cannot decrypt part-file 4. The symmetrically encrypted part-file 4 and the asymmetrically encrypted symmetric key 7 associated therewith are then transmitted in the step indicated with arrow E to target location 9 and received there via a network, for instance internet.

File 10 received at target location 9 comprises the symmetrically encrypted part-file 4 and the associated asymmetrically encrypted symmetric key 7. The received file 10 is then encrypted using a symmetric key 11 in the step indicated with F. This symmetric key 11 is symmetrically encrypted using a public key 8 originating from target location 2 by means of a step indicated with arrow G. It is hereby certain that the received file 10 cannot be decrypted without the private key associated with public key 8. Public key 8 may have been sent together with received file 10, but may also be already present at the target location. Public key 8 used in this step does not have to be the same public key as used in the encryption at the source location. The file 10, received symmetrically encrypted, and the asymmetrically encrypted symmetric key 11 associated therewith are then stored on storage medium 12 in a step indicated with arrow H.

As shown, part-files 5 and 6 are stored in the same manner at target locations 13 and 14. The whole file 1 is thus not stored at one of the target locations 9, 13, 14.

If the owner needs the file 1 given into safekeeping, he/she retrieves from the three locations 9, 13, 14 the encrypted part-files stored there. These part-files 4, 5 and 6 must first be decrypted in reverse sequence before they can be merged. Because only the owner has the private key associated with public key 8, the decryption must take place in his/her presence, for instance at the source location.

FIG. 1 shows the step of compressing the file at the source location. This step can however also be omitted or be performed at a different time.

FIG. 1 shows that the compressed file is divided into three parts. The compressed file can also be divided into more or fewer parts, depending on for instance the desired extent of distribution and desired redundancy.

FIG. 1 shows that each part-file is encrypted before being sent to a target location. The part-file can however also be transmitted in unencrypted manner, for instance if the owner completely trusts the recipient(s).

FIG. 1 shows that the part-file is encrypted both before transmission thereof and after receipt thereof by first symmetrically encrypting thereof using a symmetric key and then asymmetrically encrypting this symmetric key using a public key originating from the source location. The part-file can however also be asymmetrically encrypted in its entirety using the public key without first being symmetrically encrypted. The owner can only symmetrically encrypt the part-file before transmission thereof. He/she must then however save the symmetric key him/herself and not send it to the target location.

FIG. 1 shows the irreversible encryption at the target location by means of the asymmetric encryption using a public key originating from the source location. The irreversible encryption could however also take place by means of a key from the target location. In this case the key must remain secret from the recipient. This can be realized for instance by having encryption take place in an automated, unavoidable process over which the recipient has no influence. In that case the irreversible encryption applied at the target location can also be removed at the target location when the part-file is retrieved by the owner.

1. Method for storing a file originating from a source location at a target location, comprising of:
receiving the file at the target location,
storing the file at the target location,
characterized by
encrypting the file prior to receipt using a key originating from the source location, and
encrypting the file irreversibly in at least stored state at the target location using a key originating from the source location, this prior to storage at the target location.

2. Method as claimed in claim 1,
characterized in that
irreversible encryption of the file comprises of:
asymmetric encryption of the file using a public key originating from the source location.

3. Method as claimed in claim 1,
characterized in that
irreversible encryption of the file comprises of:
generating a symmetric key,
symmetrically encrypting the file using the symmetric key, and
asymmetrically encrypting the symmetric key using a public key originating from the source location.

4. Method as claimed in any of the foregoing claims,
characterized by
irreversibly encrypting the file after receipt.

5. Method as claimed in any of the foregoing claims,
characterized in that
the target location is a network location such as an internet location or a LAN (Local Area Network) location.

6. Method as claimed in any of the foregoing claims,
characterized in that
encryption of the file prior to receipt comprises of:
asymmetrically encrypting the file using a public key originating from the source location.

7. Method as claimed in any of the claims 1-5,
characterized in that
encryption of the file prior to receipt comprises of:
generating a symmetric key,
symmetrically encrypting the file using the symmetric key, and
asymmetrically encrypting the symmetric key using a public key originating from the source location.

8. Method as claimed in any of the foregoing claims,
characterized in that
the key originating from the source location during the encryption of the file prior to receipt and the key originating from the source location during the irreversible encryption of the file at the target location are the same.

9. Method as claimed in any of the foregoing claims,
characterized by
compressing the file prior to receipt.

10. Method as claimed in any of the foregoing claims,
characterized by
dividing the file into at least two part-files prior to receipt.

11. Method as claimed in claim 10,
characterized by
distributing the part-files over more than one target location.

12. Method as claimed in claim 11,
characterized by
distributing the part-files over the target locations such that no one target location stores all of the part-files.

13. Method as claimed in any of the claims 11 and 12,
characterized by
distributing the part-files over the target locations by means of an error correction algorithm, for instance a Reed Solomon error correction algorithm.

14. Receiving device for storing a file originating from a source location at a target location, comprising:
a receiving unit which receives the file at the target location,
an encryption unit which encrypts the file at the target location,
a storage unit which stores the file at the target location,
characterized in that
the encryption unit encrypts the file irreversibly in at least a stored state at the target location using a key originating from the source location.

15. System for storing a file originating from a source location at least one target location, comprising:
a transmitting device at the source location which transmits the file from the source location to the at least one target location, and
a receiving device at the target location, comprising:
a receiving unit which receives the file at the target location,
an encryption unit which encrypts the file at the target location,
a storage unit which stores the file at the target location,
characterized in that
the encryption unit encrypts the file irreversibly in at least a stored state at the target location using a key originating from the source location.

16. System as claimed in claim 15,
characterized in that
the transmitting device comprises at least one of a dividing unit, a compressing unit, an encryption unit and a distributing unit.
